(19) United States
(12) Patent Application Publication
(10) Pub. No.: US 2021/0168641 A1
(43) Pub. Date: Jun. 3, 2021

(54) Measurement Reporting for Radio Access Network

(71) Applicant: Telefonaktiebolaget LM Ericsson (publ), Stockholm (SE)

(72) Inventors: Mattias Frenne, Uppsala (SE); Siva Muruganathan, Stittsville (CA); Shiwei Gao, Nepean (CA); Claes Tidestav, Bålsta (SE); Robert Mark Harrison, Grapevine, TX (US); Stephen Grant, Pleasanton, CA (US)

(21) Appl. No.: 17/047,854

(22) PCT Filed: May 17, 2018
(86) PCT No.: PCT/SE2018/050509

§ 371 Date: Oct. 15, 2020

(51) Int. Cl. H04W 24/10; H04W 24/08; H04L 5/00

(52) U.S. Cl. CPC H04W 24/10; H04L 5/0048; H04W 24/08

(57) ABSTRACT

There is described a method of operating a measuring radio node (10, 100) in a radio access network, the method comprising transmitting measurement reporting to the radio access network, the measurement reporting being based on measurement performed on received data signaling.

The disclosure also pertains to related devices and methods.

### TECHNICAL FIELD

This disclosure pertains to wireless communication technology, in particular for Radio Access Technology for the 5th Generation.

### BACKGROUND

In radio access technology, measurements are performed by user equipments (UEs) based on specific reference signals like CSI-RS (Channel State Information-Reference Signals). Based on the measurements, reports are transmitted back to the transmitter of the CSI-RS, usually a network node, to facilitate selection of suitable transmission modes, in particular regarding use of a suitable Modulation and Coding Scheme (MCS), which is referred to as link adaptation. The increase of the range of frequencies usable for telecommunication, and a wide variety of new use cases, motivates changes to measurement reporting, in particular in the context of link adaptation.

### SUMMARY

It is an object of the present disclosure to describe approaches for improved measurement reporting, in particular in the context of link adaptation. The approaches are particularly advantageously implemented in a 5th Generation (5G) telecommunication network or 5G radio access technology or network (RAT/RAN), in particular according to 3GPP (3^{rd} Generation Partnership Project, a standardisation organization). A suitable RAN may in particular be a RAN according to NR, for example release 15 or later, or LTE Evolution.

There is disclosed a method of operating a measuring radio node in a radio access network. The method comprises transmitting measurement reporting to the radio access network, the measurement reporting being based on measurement performed on received data signaling.

Also, a measuring radio node for a radio access network is described. The measuring radio node is adapted to transmit measurement reporting to the radio access network, the measurement reporting being based on measurement performed on received data signaling. The measurement radio node may comprise, and/or be adapted to utilise, processing circuitry and/or radio circuitry, in particular a transceiver and/or transmitter and/or receiver, and/or measuring circuitry, for performing the measurement and/or forming the measurement reporting and/or transmitting the reporting. Alternatively, or additionally, the measuring radio node may a comprise a corresponding measuring module and/or forming module and/or transmitting module.

A measuring radio node may be any radio node adapted to perform measurement. In particular, it may be a user equipment. However, in some cases, in particular in backhaul or relay scenarios, it may be implemented as a network node, for example a relay node, or small node, or gNB or eNB.

There is also considered a method of operating a signaling radio node in a radio access network. The method comprises performing link adaption for signaling based on measurement reporting received from a measuring radio node, the measurement reporting being based on measurement performed on data signaling transmitted to the measuring radio node.

Moreover, a signaling radio node for a radio access network is described. The signaling radio node is adapted to perform link adaption for signaling based on measurement reporting received from a measuring radio node, the measurement reporting being based on measurement performed on data signaling transmitted to the measuring radio node. The signaling radio node may comprise processing circuitry and/or radio circuitry, in particular a transceiver and/or receiver and/or transmitter, for receiving the measuring reporting and/or performing the link adaptation and/or for transmitting signaling like the data signaling and/or control signaling.

A signaling radio node may be a radio node adapted for link adaptation. The signaling radio node may in particular be a network node, e.g. a eNB or gNB. However, in some scenarios, it may be a user equipment, e.g. in a sidelink scenario.

Data signaling may be in downlink, e.g. transmitted by a signaling radio node. However, in some cases, it may be in sidelink or even in uplink, e.g. if a UE performs link adaption. The measurement reporting may be in the complementary communication direction. The radio access network may represent one or more signaling radio nodes.

Performing measurement may comprise performing one or more measurements, e.g. taking one or more samples. Measurement may be performed during reception of data signaling, and/or after reception has finished, e.g. on stored representation of the signaling. In general, measurement may be performed on a reference source, which may correspond to a resource structure, e.g. in time and/or frequency. The resource structure may comprise one or more resource elements and/or PRBs. Data signaling may be associated to, and/or received in the resource structure or reference source. The data signaling may comprise data-specific reference signaling, e.g. DM-RS and/or PT-RS, and/or information signaling carrying higher-layer information, e.g. the data, and/or coding bits from error detection and/or correction coding, or a representation thereof. Resource elements carrying such reference signaling may be interspersed between resource elements carrying data, and/or be frontloaded (earlier in time) and/or back-loaded (trailing in time). The reference signaling may be used for demodulating and/or decoding the data. A resource element may carry (be associated to) a modulation symbol representing a number of bits or for reference signaling, a reference symbol. The reference source may comprise resource elements associated to, and/or carrying, information signaling and/or resource elements associated to, and/or carrying, data-specific reference signaling. Data signaling may be associated to a data channel, which may be a physical channel, in particular a dedicated or shared channel. Examples of data channels comprise PSSCH and PDSCH. The data signaling may be slot-based, or in some cases mini-slot based. In general, the data signaling may pertain to one instance of data signaling, e.g. continuous in time between a starting symbol and an ending symbol of the data signaling. However, in some cases, multiple instances, e.g. with interrupted signaling, may be comprised, e.g. in the context of mini-slots or pre-emption of mini-slot signaling in a longer transmission.

Measurement reporting may represent the performed measurement, e.g. one or more characteristics and/or parameters of the received data signaling, and/or one or more characteristics or parameters based on the measurement, e.g. determined and/or derived therefrom, e.g. using estimate and/or calculation and/or modelling. The measurement reporting may pertain to, and/or indicate and/or represent the received data signaling, and/or a preferred signaling characteristic (e.g., of future data signaling or control signaling), which may be based on the received signaling. A characteristic may indicate a difference or deviation between received and configured or preferred signaling, e.g. as indicated in control information. Measurement reporting may comprise one or more indicators and/or values associated to the performed measurements, e.g. a Received Quality Indication/Indicator, RQI. It may be considered that measurement reporting is formed based on the performed measurement, in particular based on a reception quality estimate and/or signal quality of the received data signaling, which may be determined based on one or more measured characteristics or attributes of the received signaling, e.g. determined and/or derived therefrom. The measurement reporting may be formed based on assumptions of transmission conditions for future and/or preferred transmission modes or transmission characteristics.

In some cases, the measurement reporting may be combined with, and/or include, and/or be jointly encoded, with control information, in particular UCI and/or CSI reporting and/or acknowledgement information and/or scheduling request and/or beam-related information, which may pertain to a beam characteristic of a beamformed beam used for transmitting the data signaling.

Measurement reporting may be configured to the measuring radio node, e.g. with control signaling, which may be physical layer signaling like DCI or SCI, or higher-layer signaling like RRC or MAC signaling. Timing and/or periodicity and/or resources (e.g. time/frequency resources, and/or resource set/s and/or pool/s available) may be configured or indicated, in particular with higher-layer signaling. Control signaling like DCI or SCI may indicate resource/s and/or resource set/s and/or pool/s, e.g. with a physical resource indicator. The reporting may be configured to be periodical, to be provided at configured regular periodic times. In some cases, it may be aperiodic, e.g. individually triggered, e.g. with a DCI message like a scheduling assignment or grant. Physical layer signaling may comprise one or more indicators indicating one or more sets or parameters or resources, and/or one or more elements of one or more sets, configured with higher layer signaling.

In general, measurement reporting may be triggered by control signaling. The control signaling may be physical control signaling, and/or be associated to a physical control channel, which may be a dedicated or common or shared channel. In some cases, control signaling may utilise DCI or SCI, and/or be associated to PDCCH or PSCCH. The control signaling may be received in the same slot as the data signaling, or in a slot before. There may be considered that the control signaling comprises an indication indicating whether measurement reporting or CSI reporting is to be triggered for a reporting instance (e.g., scheduled PUCCH or PUSCH transmission), e.g. the next reporting instance in time, or other configured instance. In some case, the indicator may indicate combined reporting.

Performing link adaptation may comprise transmitting signaling based on the link adaption, and/or using an adapted transmission scheme, in particular pertaining to a MCS and/or physical transmission characteristic and/or code rate and/or coding and/or transmission power; link adaptation may generally be considered representing adapting one or more of such, or corresponding, parameter/s, e.g. based on the measurement reporting. Such transmitted signaling may be control signaling and/or data signaling transmitted after the data signaling on which measurement is performed.

It may be considered that the measurement reporting pertains to one or more characteristics of data signaling, in particular of the received data signaling and/or future data signaling, in which case the characteristics may comprise one or more preferences.

The measurement reporting may be used for link adaption utilised for data signaling and/or control signaling. Such use may be in a closed loop. The measuring radio node may use the reporting for indicating a preferred transmission characteristic for the link adaptation.

In some cases, the measurement reporting may be based on a measurement reference associated to the data signaling. A measurement reference may be reference signaling, e.g. data-specific reference signaling, or in some cases other reference signaling, e.g. CSI-RS and/or pilot signaling and/or sounding reference signaling, e.g. SRS if the signaling radio node is implemented as UE or terminal.

The measurement reporting may pertain to one instance of data signaling, and/or one or more slots, and/or a number N of symbols (in time) carrying data signaling, wherein N may be 1 or larger and/or 13 or smaller, in particular between 1 and 3. In some cases, N may be larger than 13, e.g. for slot-aggregation scenarios and/or for transmission across slot borders. The data signaling may be arranged arbitrarily in a slot structure.

The measurement reporting may pertain to, and/or represent and/or indicate, a characteristic of the received data signaling based on which link adaptation for subsequent (future) data signaling and/or control signaling is performed, e.g. a signal quality, and/or BER, or BLER or SNR or SINR or SIR, and/r a preferred MCS and/or a deviation or difference from a target value. A target value may be indicated by control signaling, e.g. physical layer signaling (e.g., in a DCI scheduling the data signaling) and/or higher-layer signaling.

In some variants, the measurement reporting may also be based on measurement on reference signaling, e.g. data-specific reference signaling, and/or CSI-RS or SRS.

There is also considered a program product comprising instructions adapted for causing processing circuitry to control and/or perform a method as described herein. A carrier medium arrangement carrying and/or storing a program product as disclosed may be considered. Also, a system comprising at least one signaling radio node and at least one measuring radio node may be considered, as well as an associated information system.

The measurement reporting may be transmitted on a channel, like a physical channel, and/or be associated to a physical layer. The channel may be a control channel, or a data channel, and/or a dedicated channel, or a common or shared channel, and/or a URLLC channel. It may be considered that the measurement reporting is transmitted in a PUCCH or PSCCH, or PUSCH or PSSCH (e.g., analogous to UCI on PUSCH, which may use rate-matching or puncturing). The measurement reporting may be comprised in a single message, and/or represent a single parameter or value, or a plurality of parameters or values. A single message may comprise additional information, e.g. control information like UCI or SCI (e.g. CSI reporting and/or scheduling request and/or acknowledgement information).

The approaches described herein facilitate improved measurement reporting, based on actually received data signaling, providing improved accuracy. This in particular facilitates improved and more efficient link adaptation.

### BRIEF DESCRIPTION OF THE DRAWINGS

The drawings are provided to illustrate concepts and approaches described herein, and are not intended to limit their scope. The drawings comprise:

FIG. 1, showing an exemplary radio node implemented as terminal or UE; and

FIG. 2, showing an exemplary radio node implemented as network node.

### DETAILED DESCRIPTION

In the following, concepts and approaches are illustrated exemplarily referring to 3GPP systems, in particular NR. However, they may be applied to other systems. A UE may be considered an example of a measuring radio node, a gNB an example of a signaling radio node. The network may represent one or more signaling radio nodes. PDSCH signaling may be considered to represent data signaling.

In particular to facilitate link adaptation in wireless communication systems, the user equipment (UE) measures a radio channel representation and sends corresponding channel state information (CSI) report to the network, also known as CSI feedback or measurement report. The network then uses this information to adjust the modulation and coding scheme (MCS), the preferred precoding matrix and the number of MIMO layers (rank) for the transmission, as representing link adaptation. The network also directly uses the preferred precoding matrix, and/or may compute a transmit multi-antenna precoding matrix based on the CSI report from one or multiple UEs (in case of MU-MIMO scheduling), which determines how each transmitted data layer is transmitted from each of the multiple transmit antennas.

For CSI feedback in LTE and NR, an implicit CSI mechanism is adopted, wherein a UE recommends a transmission configuration for the measured channel from the transmit antennas to the receive antennas at the UE. The CSI feedback is provided to reach a block error (BLER) rate target such as 10%, that is either specified (fixed) or configured to the UE by the network.

In LTE and NR, the CSI feedback is given in terms of a transmission rank indicator (RI), a precoder matrix indicator (PMI), and one or two channel quality indicator(s) (CQI). In addition, a CSI-RS resource indication (CRI) can also be configured, in case the UE is configured to measure and select among multiple CSI-RS resources. The CQI/RI/PMI/CRI report can be wideband or frequency selective depending on which reporting mode that is configured.

The RI corresponds to a recommended number of streams that are to be spatially multiplexed and thus transmitted in parallel over the effective channel. The PMI identifies a recommended precoder (in a codebook which contains precoders with the same number of rows as the number of CSI-RS ports) for the transmission, which relates to the spatial characteristics of the effective channel.

The CQI represents a recommended transport block size (i.e., code rate or spectral efficiency) for a given reference transmission hypothesis (bandwidth, overhead, etc.) and LTE and NR support transmission of one or two simultaneous (on different layers) transmissions of transport blocks (i.e. separately encoded blocks of information) to a UE in a subframe. There is thus a relation between a CQI and an SINR of the spatial stream(s) over which the transport block or blocks are transmitted.

Note that the CSI feedback is based on a hypothetical transmission and based on measurements of specific, well-defined reference signals like CSI-RS. For the hypothetical transmission it is assumed that the network is using the reported PMI, CRI and RI, and for a certain PDCCH overhead, DMRS overhead, a fixed encoder redundancy version, no CSI-RS overhead, no phase tracking RS (PT-RS) overhead, a fixed PRB bundling (2 RB) and a fixed scheduling bandwidth and so forth.

The granularity of the CSI feedback, which is a closed loop feedback from the UE to the network, is rather coarse, roughly in steps of 2 dB receive SINR. Typically, a network is additionally using an open loop link adaptation (OLLA), where the reported CQI is adjusted into a corrected value in order to meet the desired target bit rate or transport block error rate. The adjustment is made based on CSI feedback history. The output from this algorithm is then used to adjust and determine the modulation and coding scheme (MCS) for the scheduled PDSCH signaling. After some time, the OLLA has converged to a stable link adaptation with small errors provided that long enough time has been given to the algorithm and that the UE has been scheduled PDSCH to base the adjustments on.

Although NR and LTE have support for link adaptation by the CSI feedback, which can be configured for a rather short feedback periodicity, the current CSI framework does not allow for “true link adaptation” and requires OLLA convergence. The current CSI feedback is based on the hypothetical PDSCH transmission and is an approximation of a true transmission.

The CSI framework in current systems thus come with a number of drawbacks and problems, one or more of which may be ameliorated or overcome with approaches described herein:
OLLA convergence is slow and not suitable for bursty traffic patterns, using short packages that can be completed using a few (e.g. less than 5) PDSCH transmissions. It is thus a problem how to achieve good link adaptation for small packets with current CSI framework
CSI feedback is based on CSI-RS which are reference signals sparse in time and in frequency, while DMRS associated to data signaling are much more dense, which leads to inaccuracies when emulating the channel used for the PDSCH transmission
CSI feedback is codebook based, and thus bound to the codebook transmission hypothesis, while the network may use a different transmission precoder, not part of a specified codebook; thus the CSI report may be inaccurate
CSI feedback is based on a set of transmission hypotheses assumptions, for example the PRB bundling is set to 2 RB while in reality a different PRB bundling size may be used, which creates an error in channel estimation performances.
CSI calculation in the UE may be simplified and may not take into account all benefits of the advanced receiver in order to keep the complexity low. Hence, the CSI feedback does not reflect the true reception of the PDSCH signaling and link adaptation based on CSI is inaccurate; e.g., codebook search to determine the preferred precoder is computationally intensive, and shortcuts are taken on other parts, e.g. estimating the interference covariance may be simplified, which leads to CSI inaccuracies
For the same reason, CSI feedback may not model/parameterize receiver impairments accurately
When computing CSI feedback the effect of phase noise for mm-waves is not taken into account, which may impact the PDSCH, while the impact of phase noise on CSI-RS is zero or small.
The effects of synchronization errors on PDSCH is not taken into account in CSI feedback
The effects of demodulation loss due to channel estimation errors when using DMRS is not considered in CSI feedback
The CSI feedback may account for interference inaccurately as a simplified algorithm may be used for CSI estimation compared to when PDSCH is demodulated, and/or there is a long delay between CSI report and the actual PDSCH transmissions
When estimating CSI in the UE; the inter-stream interference for MIMO may be inaccurately modeled/parameterized
When estimating CSI in the UE; the interference variation between scheduled T/F resources for PDSCH and T/F resources used for CSI estimation may be different

According to one approach, it may be considered configuring the UE to report reception quality metric(s) for the actually received PDSCH signaling, e.g. represented by a reception quality indicator (RQI), which may be considered a post-reception quality measure or reception quality estimate. The RQI is associated with a PDSCH signaling reception at the UE and is feed back or reported from the UE to the network. Using the RQI, the network can quickly (using e.g. a single RQI) adjust the MCS for the subsequent PDSCH transmission to the UE. Hence, very rapid and true link adaptation is obtained, since it is based on a real PDSCH transmission and not on a hypothesized transmission as in the case of CSI feedback.

The network can use either or of both CSI feedback (based on a hypothesis) and RQI feedback (based on an actual transmission) to perform link adaptation. The CSI feedback may, e.g., be used to adjust the parameters for the initial transmission, while RQI may be used to adjust the parameters (e.g. MCS) for the subsequent transmissions to the same UE.

The network can also utilize the CSI feedback and the RQI feedback and compare them, to get an estimate of how much the CSI based link adaptation is off the true link performance, e.g. alleviating the need for an OLLA algorithm, since the difference can directly be compensated.

One example of a RQI is the post receiver MCS. Hence, the UE estimates, based on the received PDSCH signaling, a MCS that would lead to the BLER target. The UE can thus, based on attributes related to the reception of the PDSCH signaling, report that the used MCS was (e.g., far) off compared to the MCS the UE has received in the scheduling DCI, or how much it was off. In one example, the UE reports a differential MCS, computed as the difference between the scheduled MCS and the post-reception estimated MCS.

The RQI feedback provides the network with information that allows the scheduler to perform link adaptation that takes into account the true overhead, true PRB bundling, true receiver performance based on demodulation reference signals instead of the sparse CSI-RS etc.

Link adaptation can converge much faster to an operating point that gives performance close to the target BLER. Hence, performance and latency are improved in particular for small packets.

A method in a wireless device (UE) for reception quality information (RQI) feedback to the network (NW) is described, as well as a corresponding UE. The UE may be configured by higher layer, such as radio resource configuration (RRC) signaling, to calculate and feed back RQI. the UE may then receive, from a network node, a scheduling message (scheduling assignment) in a downlink control information (DCI) message which schedules a physical shared data channel transmission (PDSCH), which the UE may receive. The UE may perform measurement, e.g. determining a reception quality estimate, for the reception of the PDSCH signaling.

The reception quality estimate in the UE may be based on one or more characteristics like attributes, intermediate variables or estimates related to the reception of the data channel, respectively the data signaling. A characteristic, an attribute, variable or estimate may represent or parametrize or indicate a quality or feature regarded as a characteristic, and/or inherent part, of the particular PDSCH signaling, and/or be associated to bits of the information, e.g. in a transport block, carried by the PDSCH signaling.

Attributes, variables or measurements may for instance pertain to and/or comprise and/or be represented by the actual PDSCH bits or modulated symbols, the log likelihood ratio (LLR) values, the soft bits used in the decoder or after termination of the decoder, interference covariance, receiver type, knowledge of attributes of co-scheduled users.

The characteristic or reception quality estimate may be determined from resource elements carrying PDSCH signaling, possibly combined with information originating from higher layers. One or more resource elements carrying data channel (PDSCH) transmission may be utilised. Hence, these resource elements may be considered reference resource elements for the RQI estimation.

The UE may determine a RQI based on the reception quality estimates, where RQI is one or more of the following metrics: a preferred MCS, preferred code rate, BLER, SINR or bit error rate. A metric can be based on a differentially calculated value from the value in the scheduling DCI or a higher layer configured value, e.g. target MCS-scheduled MCS, target BLER-configured BLER. The RQI may be considered a characteristic of the data signaling that is based on other (e.g., measured) characteristics.

The UE may transmit, to the network node, the RQI report, which then may adjust subsequent PDSCH transmission based on the RQI report, or based on a CSI report and RQI report combined, performing link adaptation.

The data channel transmission or data signaling (PDSCH) may be scheduled by a control channel message or control information message like a DCI carried by PDCCH, or may be configured with higher layer signaling, e.g. for semi-persistent scheduling. It may be considered that a control information message may contain a RQI feedback indication, which may indicate and/or provide the configuration to feed back RQI, for example to allow for dynamic control on whether RQI should be feed back for the PDSCH or not. Such indication may in some cases indicate resources for the feedback, e.g. time and/or frequency and/or code resources, and/or a set of resources, e.g. for PUCCH or PUSCH, which may be configured with higher layer signaling.

In one variant, a trigger to feed back RQI may be in the same DCI that schedules the data signaling transmission, which may be considered an example of an aperiodic trigger of RQI feedback. Furthermore, the trigger may be jointly encoded with a PUCCH resource indicator or a PUSCH resource indicator in the DCI. The presence of the trigger information element or code point (state) in DCI may be configured by higher layer signaling (e.g. RRC or MAC CE).

It may be considered that the RQI report may be feed back together with acknowledgement signaling like HARQ-ACK, which may pertain to the same data signaling, and/or other UCI or SCI, or in a higher layer configured PUCCH or PUSCH resource possibly in a different slot than the HARQ-ACK associated to the same PDSCH that the RQI is associated to. RQI in this case may take more time to estimate than the HARQ-ACK, and some more time can be allowed by feeding back RQI later than the HARQ-ACK.

It may be considered that RQI report is triggered by an UL grant (scheduling grant). The UL grant may contain an indication or pointer to a particular data signaling like PDSCH signaling for which the RQI should be reported in PUCCH or PUSCH. The indication or pointer may comprise, or consist of, a HARQ process identifier; the UE should then report on a particular PDSCH as identified by the HARQ process ID, for example the most recent transmitted PDSCH with this HARQ process ID or the most recent transmitted PDSCH with this HARQ process ID no later than a certain point in time as computed relative to the triggering occasion/slot/subframe. For example, the CSI reference resource can be used or a RQI reference resource can be defined.

The measurement may be performed, and/or reception quality estimates may be determined, for example using PTRS (Phase-Tracking RS) overhead and/or phase tracking estimates, if such are associated and/or configured for the data signaling/transmission,

It may be considered that the characteristic measured or determined, e.g. the reception quality estimate, is based on the PRB bundling size used for the actual data transmission. The PRB bundling size may indicate a number of PRBs grouped together for resource allocation and/or transmission.

For measuring and/or determining the estimate or reception quality estimate, a residual signal after signal regeneration and subtraction in an iterative (Turbo) IC receiver may be used, and/or a computation of the average SINR over the PDSCH REs may be used.

Resource elements used for measuring and/or determining reception quality estimates (representing the RQI reference resource) may be comprised within the data channel (i.e. PDSCH REs) transmission region. Alternatively, or additionally, resource elements used may be comprised within the reference signal (i.e. DMRS REs and PTRS REs if present) transmission region. The relative power ratio per resource element between PDSCH RE and DMRS RE may then be signalled from NW to the UE, e.g. by DCI, or MAC CE, or RRC. A transmission region may represent the time/frequency space in which the transmission is located, e.g. a set of REs and/or PRBs.

It may be considered that the reference resource and/or signaling and/or measuring trigger may be considered not valid if the downlink grant is not received, e.g. if the UE still receives an uplink grant triggering a CSI report and/or the RQI report, and/or the report is periodic, e.g. configured with higher-layer signaling.

The same feedback channel can be used for RQI and CQI, while the reference resource may be dynamically switched between the CSI reference resource and the RQI reference resource. Based on the control information, e.g. a dynamic indication or indicator, the feedback channel may contain CSI or RQI. In one example, the feedback or report, or feedback channel, may comprise or transmit CSI if triggered by an UL grant in DCI, while it transmits RQI if triggered by a DL assignment in DCI.

It may be considered that symbols in the slot that may carry DMRS+PDSCH may be excluded from the reference resource (since DMRS for other UEs may collide with REs for PDSCH for the served UE).

In one variant, the reference resource may be only valid in one slot, or in one PDSCH. The UE may be configured or adapted to only use one data signaling instance (e.g., per slot), or in some cases to use multiple PDSCH receptions to estimate RQI, e.g. for one or more slots, in particular in the context of slot aggregation and/or transmission of data-signaling across slot-borders. For example, a PDSCH triggered by CS-RNTI may be considered, which indicates repetition of the same PDSCH multiple times, in which case the reference resource for RQI can span across the multiple repeated PDSCHs.

There may generally be considered a method in a wireless device for reception quality information (RQI) feedback to the network. The method may comprise receiving, from a network node, a data channel transmission and performing a reception quality estimate based on attributes, intermediate variables or estimates related to the reception of the data channel, as well as determining a RQI based on the reception quality estimates and transmitting, to the network node, a RQI report. Attributes, variables or estimates may be one or more of demodulation reference signals, actual PDSCH bits, resource elements containing PDSCH, LLR values, soft bits, interference covariance, receiver type, knowledge of attributes of co-scheduled users. A reference resource for computing RQI may be among the RE used for reception of the scheduled PDSCH and/or the associated DMRS. RQI may represent one or more of the following metrics: a preferred MCS, preferred code rate, BLER, SINR or bit error rate of the received PDSCH. A metric may be based on a differentially calculated value from the value in the scheduling DCI or a higher layer configured value, e.g., target MCS-scheduled MCS, target BLER-configured BLER. The data channel transmission may be scheduled by a control channel message. The control channel message may contain the configuration to feed back RQI. The configuration to feed back RQI may be in the same DCI that schedules the data transmission, it may be jointly encoded with a PUCCH resource indicator. The RQI report may be fed back together with the HARQ-ACK, or in a configured PUCCH resource with other UCI, or in a different slot or transmission than HARQ-ACK. The RQI report may be configured to be fed back, or fed back aperiodically, e.g. triggered by an UL grant, which may contain an associated HARQ process ID. The aperiodic feedback may be carried by PUSCH or PUCCH. The reception quality estimates may use PTRS and/or phase tracking estimates, if present in the data transmission. The reception quality estimates may in general use the residual signal after signal regeneration and subtraction in an iterative (Turbo) IC receiver.

The terms data signaling, data transmission, data channel transmission may be considered equivalent. PDSCH signaling, PDSCH transmission or similar may also be considered equivalent, and represent an example of data signaling. It should be noted that transmitting report or measurement reporting may be considered feedback or feeding back the corresponding information.

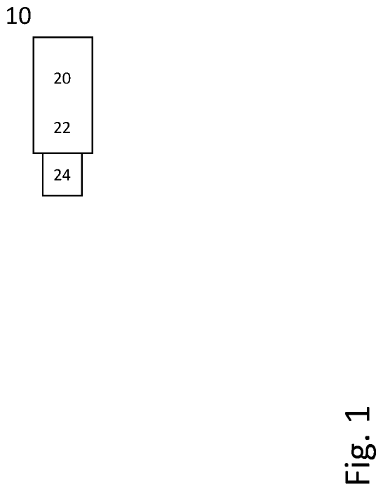

FIG. 1 schematically shows a radio node, in particular a terminal or wireless device 10, which may in particular be implemented as a UE (User Equipment). Radio node 10 comprises processing circuitry (which may also be referred to as control circuitry) 20, which may comprise a controller connected to a memory. Any module of the radio node 10, e.g. a communicating module or determining module, may be implemented in and/or executable by, the processing circuitry 20, in particular as module in the controller. Radio node 10 also comprises radio circuitry 22 providing receiving and transmitting or transceiving functionality (e.g., one or more transmitters and/or receivers and/or transceivers), the radio circuitry 22 being connected or connectable to the processing circuitry. An antenna circuitry 24 of the radio node 10 is connected or connectable to the radio circuitry 22 to collect or send and/or amplify signals.

Radio circuitry 22 and the processing circuitry 20 controlling it are configured for cellular communication with a network, e.g. a RAN as described herein, and/or for sidelink communication. Radio node 10 may generally be adapted to carry out any of the methods of operating a radio node like terminal or UE disclosed herein; in particular, it may comprise corresponding circuitry, e.g. processing circuitry, and/or modules.

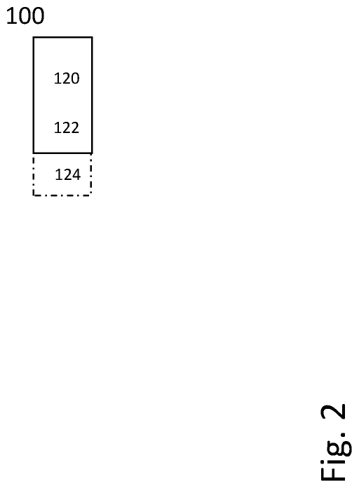

FIG. 2 schematically show a radio node 100, which may in particular be implemented as a network node 100, for example an eNB or gNB or similar for NR. Radio node 100 comprises processing circuitry (which may also be referred to as control circuitry) 120, which may comprise a controller connected to a memory. Any module, e.g. transmitting module and/or receiving module and/or configuring module of the node 100 may be implemented in and/or executable by the processing circuitry 120. The processing circuitry 120 is connected to control radio circuitry 122 of the node 100, which provides receiver and transmitter and/or transceiver functionality (e.g., comprising one or more transmitters and/or receivers and/or transceivers). An antenna circuitry 124 may be connected or connectable to radio circuitry 122 for signal reception or transmittance and/or amplification. Node 100 may be adapted to carry out any of the methods for operating a radio node or network node disclosed herein; in particular, it may comprise corresponding circuitry, e.g. processing circuitry, and/or modules. The antenna circuitry 124 may be connected to and/or comprise an antenna array. The node 100, respectively its circuitry, may be adapted to perform any of the methods of operating a network node or a radio node as described herein; in particular, it may comprise corresponding circuitry, e.g. processing circuitry, and/or modules. The radio node 100 may generally comprise communication circuitry, e.g. for communication with another network node, like a radio node, and/or with a core network and/or an internet or local net, in particular with an information system, which may provide information and/or data to be transmitted to a user equipment.

References to specific resource structures like transmission timing structure and/or symbol and/or slot and/or mini-slot and/or subcarrier and/or carrier may pertain to a specific numerology, which may be predefined and/or configured or configurable. A transmission timing structure may represent a time interval, which may cover one or more symbols. Some examples of a transmission timing structure are transmission time interval (TTI), subframe, slot and mini-slot. A slot may comprise a predetermined, e.g. predefined and/or configured or configurable, number of symbols, e.g. 6 or 7, or 12 or 14. A mini-slot may comprise a number of symbols (which may in particular be configurable or configured) smaller than the number of symbols of a slot, in particular 1, 2, 3 or 4 symbols. A transmission timing structure may cover a time interval of a specific length, which may be dependent on symbol time length and/or cyclic prefix used. A transmission timing structure may pertain to, and/or cover, a specific time interval in a time stream, e.g. synchronized for communication. Timing structures used and/or scheduled for transmission, e.g. slot and/or mini-slots, may be scheduled in relation to, and/or synchronized to, a timing structure provided and/or defined by other transmission timing structures. Such transmission timing structures may define a timing grid, e.g., with symbol time intervals within individual structures representing the smallest timing units. Such a timing grid may for example be defined by slots or subframes (wherein in some cases, subframes may be considered specific variants of slots). A transmission timing structure may have a duration (length in time) determined based on the durations of its symbols, possibly in addition to cyclic prefix/es used. The symbols of a transmission timing structure may have the same duration, or may in some variants have different duration. The number of symbols in a transmission timing structure may be predefined and/or configured or configurable, and/or be dependent on numerology. The timing of a mini-slot may generally be configured or configurable, in particular by the network and/or a network node. The timing may be configurable to start and/or end at any symbol of the transmission timing structure, in particular one or more slots.

There is generally considered a program product comprising instructions adapted for causing processing and/or control circuitry to carry out and/or control any method described herein, in particular when executed on the processing and/or control circuitry. Also, there is considered a carrier medium arrangement carrying and/or storing a program product as described herein.

A carrier medium arrangement may comprise one or more carrier media. Generally, a carrier medium may be accessible and/or readable and/or receivable by processing or control circuitry. Storing data and/or a program product and/or code may be seen as part of carrying data and/or a program product and/or code. A carrier medium generally may comprise a guiding/transporting medium and/or a storage medium. A guiding/transporting medium may be adapted to carry and/or carry and/or store signals, in particular electromagnetic signals and/or electrical signals and/or magnetic signals and/or optical signals. A carrier medium, in particular a guiding/transporting medium, may be adapted to guide such signals to carry them. A carrier medium, in particular a guiding/transporting medium, may comprise the electromagnetic field, e.g. radio waves or microwaves, and/or optically transmissive material, e.g. glass fiber, and/or cable. A storage medium may comprise at least one of a memory, which may be volatile or non-volatile, a buffer, a cache, an optical disc, magnetic memory, flash memory, etc.

A system comprising one or more radio nodes as described herein, in particular a network node and a user equipment, is described. The system may be a wireless communication system, and/or provide and/or represent a radio access network.

Moreover, there may be generally considered a method of operating an information system, the method comprising providing information. Alternatively, or additionally, an information system adapted for providing information may be considered. Providing information may comprise providing information for, and/or to, a target system, which may comprise and/or be implemented as radio access network and/or a radio node, in particular a network node or user equipment or terminal. Providing information may comprise transferring and/or streaming and/or sending and/or passing on the Information, and/or offering the information for such and/or for download, and/or triggering such providing, e.g. by triggering a different system or node to stream and/or transfer and/or send and/or pass on the information. The information system may comprise, and/or be connected or connectable to, a target, for example via one or more intermediate systems, e.g. a core network and/or Internet and/or private or local network. Information may be provided utilising and/or via such intermediate system/s. Providing information may be for radio transmission and/or for transmission via an air interface and/or utilising a RAN or radio node as described herein. Connecting the information system to a target, and/or providing information, may be based on a target indication, and/or adaptive to a target indication. A target indication may indicate the target, and/or one or more parameters of transmission pertaining to the target and/or the paths or connections over which the information is provided to the target. Such parameter/s may in particular pertain to the air interface and/or radio access network and/or radio node and/or network node. Example parameters may indicate for example type and/or nature of the target, and/or transmission capacity (e.g., data rate) and/or latency and/or reliability and/or cost, respectively one or more estimates thereof. The target indication may be provided by the target, or determined by the information system, e.g. based on information received from the target and/or historical information, and/or be provided by a user, for example a user operating the target or a device in communication with the target, e.g. via the RAN and/or air interface. For example, a user may indicate on a user equipment communicating with the information system that information is to be provided via a RAN, e.g. by selecting from a selection provided by the information system, for example on a user application or user interface, which may be a web interface. An information system may comprise one or more information nodes. An information node may generally comprise processing circuitry and/or communication circuitry. In particular, an information system and/or an information node may be implemented as a computer and/or a computer arrangement, e.g. a host computer or host computer arrangement and/or server or server arrangement. In some variants, an interaction server (e.g., web server) of the information system may provide a user interface, and based on user input may trigger transmitting and/or streaming information provision to the user (and/or the target) from another server, which may be connected or connectable to the interaction server and/or be part of the information system or be connected or connectable thereto. The information may be any kind of data, in particular data intended for a user of for use at a terminal, e.g. video data and/or audio data and/or location data and/or interactive data and/or game-related data and/or environmental data and/or technical data and/or traffic data and/or vehicular data and/or circumstantial data and/or operational data. The information provided by the information system may be mapped to, and/or mappable to, and/or be intended for mapping to, communication or data signaling and/or one or more data channels as described herein (which may be signaling or channel/s of an air interface and/or used within a RAN and/or for radio transmission). It may be considered that the information is formatted based on the target indication and/or target, e.g. regarding data amount and/or data rate and/or data structure and/or timing, which in particular may be pertaining to a mapping to communication or data signaling and/or a data channels. Mapping information to data signaling and/or data channel/s may be considered to refer to using the signaling/channel/s to carry the data, e.g. on higher layers of communication, with the signaling/channel/s underlying the transmission. A target indication generally may comprise different components, which may have different sources, and/or which may indicate different characteristics of the target and/or communication path/s thereto. A format of information may be specifically selected, e.g. from a set of different formats, for information to be transmitted on an air interface and/or by a RAN as described herein. This may be particularly pertinent since an air interface may be limited in terms of capacity and/or of predictability, and/or potentially be cost sensitive. The format may be selected to be adapted to the transmission indication, which may in particular indicate that a RAN or radio node as described herein is in the path (which may be the indicated and/or planned and/or expected path) of information between the target and the information system. A (communication) path of information may represent the interface/s (e.g., air and/or cable interfaces) and/or the intermediate system/s (if any), between the information system and/or the node providing or transferring the Information, and the target, over which the information is, or is to be, passed on. A path may be (at least partly) undetermined when a target indication is provided, and/or the information is provided/transferred by the information system, e.g. if an Internet is involved, which may comprise multiple, dynamically chosen paths. Information and/or a format used for information may be packet-based, and/or be mapped, and/or be mappable and/or be intended for mapping, to packets. Alternatively, or additionally, there may be considered a method for operating a target device comprising providing a target indicating to an information system. More alternatively, or additionally, a target device may be considered, the target device being adapted for providing a target indication to an information system. In another approach, there may be considered a target indication tool adapted for, and/or comprising an indication module for, providing a target indication to an information system. The target device may generally be a target as described above. A target indication tool may comprise, and/or be implemented as, software and/or application or app, and/or web interface or user interface, and/or may comprise one or more modules for implementing actions performed and/or controlled by the tool. The tool and/or target device may be adapted for, and/or the method may comprise, receiving a user input, based on which a target indicating may be determined and/or provided. Alternatively, or additionally, the tool and/or target device may be adapted for, and/or the method may comprise, receiving information and/or communication signaling carrying information, and/or operating on, and/or presenting (e.g., on a screen and/or as audio or as other form of indication), information. The information may be based on received information and/or communication signaling carrying information. Presenting information may comprise processing received information, e.g. decoding and/or transforming, in particular between different formats, and/or for hardware used for presenting. Operating on information may be independent of or without presenting, and/or proceed or succeed presenting, and/or may be without user interaction or even user reception, for example for automatic processes, or target devices without (e.g., regular) user interaction like MTC devices, of for automotive or transport or industrial use. The information or communication signaling may be expected and/or received based on the target indication. Presenting and/or operating on information may generally comprise one or more processing steps, in particular decoding and/or executing and/or interpreting and/or transforming information. Operating on information may generally comprise relaying and/or transmitting the information, e.g. on an air interface, which may include mapping the information onto signaling (such mapping may generally pertain to one or more layers, e.g. one or more layers of an air interface, e.g. RLC (Radio Link Control) layer and/or MAC layer and/or physical layer/s). The information may be imprinted (or mapped) on communication signaling based on the target indication, which may make it particularly suitable for use in a RAN (e.g., for a target device like a network node or in particular a UE or terminal). The tool may generally be adapted for use on a target device, like a UE or terminal. Generally, the tool may provide multiple functionalities, e.g. for providing and/or selecting the target indication, and/or presenting, e.g. video and/or audio, and/or operating on and/or storing received information. Providing a target indication may comprise transmitting or transferring the indication as signaling, and/or carried on signaling, in a RAN, for example if the target device is a UE, or the tool for a UE. It should be noted that such provided information may be transferred to the information system via one or more additionally communication interfaces and/or paths and/or connections. The target indication may be a higher-layer indication and/or the information provided by the information system may be higher-layer information, e.g. application layer or user-layer, in particular above radio layers like transport layer and physical layer. The target indication may be mapped on physical layer radio signaling, e.g. related to or on the user-plane, and/or the information may be mapped on physical layer radio communication signaling, e.g. related to or on the user-plane (in particular, in reverse communication directions). The described approaches allow a target indication to be provided, facilitating information to be provided in a specific format particularly suitable and/or adapted to efficiently use an air interface. A user input may for example represent a selection from a plurality of possible transmission modes or formats, and/or paths, e.g. in terms of data rate and/or packaging and/or size of information to be provided by the information system.

In general, a numerology and/or subcarrier spacing may indicate the bandwidth (in frequency domain) of a subcarrier of a carrier, and/or the number of subcarriers in a carrier and/or the numbering of the subcarriers in a carrier. Different numerologies may in particular be different in the bandwidth of a subcarrier. In some variants, all the subcarriers in a carrier have the same bandwidth associated to them. The numerology and/or subcarrier spacing may be different between carriers in particular regarding the subcarrier bandwidth. A symbol time length, and/or a time length of a timing structure pertaining to a carrier may be dependent on the carrier frequency, and/or the subcarrier spacing and/or the numerology. In particular, different numerologies may have different symbol time lengths.

Signaling may generally comprise one or more symbols and/or signals and/or messages. A signal may comprise or represent one or more bits. An indication may represent signaling, and/or be implemented as a signal, or as a plurality of signals. One or more signals may be included in and/or represented by a message. Signaling, in particular control signaling, may comprise a plurality of signals and/or messages, which may be transmitted on different carriers and/or be associated to different signaling processes, e.g. representing and/or pertaining to one or more such processes and/or corresponding information. An indication may comprise signaling, and/or a plurality of signals and/or messages and/or may be comprised therein, which may be transmitted on different carriers and/or be associated to different acknowledgement signaling processes, e.g. representing and/or pertaining to one or more such processes. Signaling associated to a channel may be transmitted such that represents signaling and/or information for that channel, and/or that the signaling is interpreted by the transmitter and/or receiver to belong to that channel. Such signaling may generally comply with transmission parameters and/or format/s for the channel.

Reference signaling may be signaling comprising one or more reference symbols and/or structures. Reference signaling may be adapted for gauging and/or estimating and/or representing transmission conditions, e.g. channel conditions and/or transmission path conditions and/or channel (or signal or transmission) quality. It may be considered that the transmission characteristics (e.g., signal strength and/or form and/or modulation and/or timing) of reference signaling are available for both transmitter and receiver of the signaling (e.g., due to being predefined and/or configured or configurable and/or being communicated). Different types of reference signaling may be considered, e.g. pertaining to uplink, downlink or sidelink, cell-specific (in particular, cell-wide, e.g., CRS) or device or user specific (addressed to a specific target or user equipment, e.g., CSI-RS), demodulation-related (e.g., DMRS) and/or signal strength related, e.g. power-related or energy-related or amplitude-related (e.g., SRS or pilot signaling) and/or phase-related, etc.

An antenna arrangement may comprise one or more antenna elements (radiating elements), which may be combined in antenna arrays. An antenna array or subarray may comprise one antenna element, or a plurality of antenna elements, which may be arranged e.g. two dimensionally (for example, a panel) or three dimensionally. It may be considered that each antenna array or subarray or element is separately controllable, respectively that different antenna arrays are controllable separately from each other. A single antenna element/radiator may be considered the smallest example of a subarray. Examples of antenna arrays comprise one or more multi-antenna panels or one or more individually controllable antenna elements. An antenna arrangement may comprise a plurality of antenna arrays. It may be considered that an antenna arrangement is associated to a (specific and/or single) radio node, e.g. a configuring or informing or scheduling radio node, e.g. to be controlled or controllable by the radio node. An antenna arrangements associated to a UE or terminal may be smaller (e.g., in size and/or number of antenna elements or arrays) than the antenna arrangement associated to a network node. Antenna elements of an antenna arrangement may be configurable for different arrays, e.g. to change the beam forming characteristics. In particular, antenna arrays may be formed by combining one or more independently or separately controllable antenna elements or subarrays. The beams may be provided by analog beamforming, or in some variants by digital beamforming. The informing radio nodes may be configured with the manner of beam transmission, e.g. by transmitting a corresponding indicator or Indication, for example as beam identify Indication. However, there may be considered cases in which the informing radio node/s are not configured with such information, and/or operate transparently, not knowing the way of beamforming used. An antenna arrangement may be considered separately controllable in regard to the phase and/or amplitude/power and/or gain of a signal feed to it for transmission, and/or separately controllable antenna arrangements may comprise an independent or separate transmit and/or receive unit and/or ADC (Analog-Digital-Converter, alternatively an ADC chain) to convert digital control information into an analog antenna feed for the whole antenna arrangement (the ADC may be considered part of, and/or connected or connectable to, antenna circuitry). A scenario in which each antenna element is individually controllable may be referred to as digital beamforming, whereas a scenario in which larger arrays/subarrays are separately controllable may be considered an example of analog beamforming. Hybrid forms may be considered.

Uplink or sidelink signaling may be OFDMA (Orthogonal Frequency Division Multiple Access) or SC-FDMA (Single Carrier Frequency Division Multiple Access) signaling. Downlink signaling may in particular be OFDMA signaling. However, signaling is not limited thereto (Filter-Bank based signaling may be considered one alternative).

A radio node may generally be considered a device or node adapted for wireless and/or radio (and/or microwave) frequency communication, and/or for communication utilising an air interface, e.g. according to a communication standard.

A radio node may be a network node, or a user equipment or terminal. A network node may be any radio node of a wireless communication network, e.g. a base station and/or gNodeB (gNB) and/or eNodeB (eNB) and/or relay node and/or micro/nano/pico/femto node and/or transmission point (TP) and/or access point (AP) and/or other node, in particular for a RAN as described herein.

The terms wireless device, user equipment (UE) and terminal may be considered to be interchangeable in the context of this disclosure. A wireless device, user equipment or terminal may represent an end device for communication utilising the wireless communication network, and/or be implemented as a user equipment according to a standard. Examples of user equipments may comprise a phone like a smartphone, a personal communication device, a mobile phone or terminal, a computer, in particular laptop, a sensor or machine with radio capability (and/or adapted for the air interface), in particular for MTC (Machine-Type-Communication, sometimes also referred to M2M, Machine-To-Machine), or a vehicle adapted for wireless communication. A user equipment or terminal may be mobile or stationary.

A radio node may generally comprise processing circuitry and/or radio circuitry. A radio node, in particular a network node, may in some cases comprise cable circuitry and/or communication circuitry, with which it may be connected or connectable to another radio node and/or a core network.

Circuitry may comprise integrated circuitry. Processing circuitry may comprise one or more processors and/or controllers (e.g., microcontrollers), and/or ASICs (Application Specific Integrated Circuitry) and/or FPGAs (Field Programmable Gate Array), or similar. It may be considered that processing circuitry comprises, and/or is (operatively) connected or connectable to one or more memories or memory arrangements. A memory arrangement may comprise one or more memories. A memory may be adapted to store digital information. Examples for memories comprise volatile and non-volatile memory, and/or Random Access Memory (RAM), and/or Read-Only-Memory (ROM), and/or magnetic and/or optical memory, and/or flash memory, and/or hard disk memory, and/or EPROM or EEPROM (Erasable Programmable ROM or Electrically Erasable Programmable ROM).

Radio circuitry may comprise one or more transmitters and/or receivers and/or transceivers (a transceiver may operate or be operable as transmitter and receiver, and/or may comprise joint or separated circuitry for receiving and transmitting, e.g. in one package or housing), and/or may comprise one or more amplifiers and/or oscillators and/or filters, and/or may comprise, and/or be connected or connectable to antenna circuitry and/or one or more antennas and/or antenna arrays. An antenna array may comprise one or more antennas, which may be arranged in a dimensional array, e.g. 2D or 3D array, and/or antenna panels. A remote radio head (RRH) may be considered as an example of an antenna array. However, in some variants, a RRH may be also be implemented as a network node, depending on the kind of circuitry and/or functionality implemented therein.

Communication circuitry may comprise radio circuitry and/or cable circuitry. Communication circuitry generally may comprise one or more interfaces, which may be air interface/s and/or cable interface/s and/or optical interface/s, e.g. laser-based. Interface/s may be in particular packet-based. Cable circuitry and/or a cable interfaces may comprise, and/or be connected or connectable to, one or more cables (e.g., optical fiber-based and/or wire-based), which may be directly or indirectly (e.g., via one or more intermediate systems and/or interfaces) be connected or connectable to a target, e.g. controlled by communication circuitry and/or processing circuitry.

Any one or all of the modules disclosed herein may be implemented in software and/or firmware and/or hardware. Different modules may be associated to different components of a radio node, e.g. different circuitries or different parts of a circuitry. It may be considered that a module is distributed over different components and/or circuitries. A program product as described herein may comprise the modules related to a device on which the program product is intended (e.g., a user equipment or network node) to be executed (the execution may be performed on, and/or controlled by the associated circuitry).

A radio access network may be a wireless communication network, and/or a Radio Access Network (RAN) in particular according to a communication standard. A communication standard may in particular a standard according to 3GPP and/or 5G, e.g. according to NR or LTE, in particular LTE Evolution.

A wireless communication network may be and/or comprise a Radio Access Network (RAN), which may be and/or comprise any kind of cellular and/or wireless radio network, which may be connected or connectable to a core network. The approaches described herein are particularly suitable for a 5G network, e.g. LTE Evolution and/or NR (New Radio), respectively successors thereof. A RAN may comprise one or more network nodes, and/or one or more terminals, and/or one or more radio nodes. A network node may in particular be a radio node adapted for radio and/or wireless and/or cellular communication with one or more terminals. A terminal may be any device adapted for radio and/or wireless and/or cellular communication with or within a RAN, e.g. a user equipment (UE) or mobile phone or smartphone or computing device or vehicular communication device or device for machine-type-communication (MTC), etc. A terminal may be mobile, or in some cases stationary. A RAN or a wireless communication network may comprise at least one network node and a UE, or at least two radio nodes. There may be generally considered a wireless communication network or system, e.g. a RAN or RAN system, comprising at least one radio node, and/or at least one network node and at least one terminal.

Transmitting in downlink may pertain to transmission from the network or network node to the terminal. Transmitting in uplink may pertain to transmission from the terminal to the network or network node. Transmitting in sidelink may pertain to (direct) transmission from one terminal to another. Uplink, downlink and sidelink (e.g., sidelink transmission and reception) may be considered communication directions. In some variants, uplink and downlink may also be used to described wireless communication between network nodes, e.g. for wireless backhaul and/or relay communication and/or (wireless) network communication for example between base stations or similar network nodes, in particular communication terminating at such. It may be considered that backhaul and/or relay communication and/or network communication is implemented as a form of sidelink or uplink communication or similar thereto.

Control information or a control information message or corresponding signaling (control signaling) may be transmitted on a control channel, e.g. a physical control channel, which may be a downlink channel or (or a sidelink channel in some cases, e.g. one UE scheduling another UE). For example, control information/allocation information may be signaled by a network node on PDCCH (Physical Downlink Control Channel) and/or a PDSCH (Physical Downlink Shared Channel) and/or a HARQ-specific channel. Acknowledgement signaling, e.g. as a form of control information or signaling like uplink control information/signaling, may be transmitted by a terminal on a PUCCH (Physical Uplink Control Channel) and/or PUSCH (Physical Uplink Shared Channel) and/or a HARQ-specific channel. Multiple channels may apply for multi-component/multi-carrier indication or signaling.

Signaling may generally be considered to represent an electromagnetic wave structure (e.g., over a time interval and frequency interval), which is intended to convey information to at least one specific or generic (e.g., anyone who might pick up the signaling) target. A process of signaling may comprise transmitting the signaling. Transmitting signaling, in particular control signaling or communication signaling, e.g. comprising or representing acknowledgement signaling and/or resource requesting information, may comprise encoding and/or modulating. Encoding and/or modulating may comprise error detection coding and/or forward error correction encoding and/or scrambling. Receiving control signaling may comprise corresponding decoding and/or demodulation. Error detection coding may comprise, and/or be based on, parity or checksum approaches, e.g. CRC (Cyclic Redundancy Check). Forward error correction coding may comprise and/or be based on for example turbo coding and/or Reed-Muller coding, and/or polar coding and/or LDPC coding (Low Density Parity Check). The type of coding used may be based on the channel (e.g., physical channel) the coded signal is associated to. A code rate may represent the ratio of the number of information bits before encoding to the number of encoded bits after encoding, considering that encoding adds coding bits for error detection coding and forward error correction. Coded bits may refer to information bits (also called systematic bits) plus coding bits.

Communication signaling may comprise, and/or represent, and/or be implemented as, data signaling, and/or user plane signaling. Communication signaling may be associated to a data channel, e.g. a physical downlink channel or physical uplink channel or physical sidelink channel, in particular a PDSCH (Physical Downlink Shared Channel) or PSSCH (Physical Sidelink Shared Channel). Generally, a data channel may be a shared channel or a dedicated channel. Data signaling may be signaling associated to and/or on a data channel.

An indication generally may explicitly and/or implicitly indicate the information it represents and/or indicates. Implicit indication may for example be based on position and/or resource used for transmission. Explicit indication may for example be based on a parametrisation with one or more parameters, and/or one or more index or indices, and/or one or more bit patterns representing the information. It may in particular be considered that control signaling as described herein, based on the utilised resource sequence, implicitly indicates the control signaling type.

A resource element may generally describe the smallest individually usable and/or encodable and/or decodable and/or modulatable and/or demodulatable time-frequency resource, and/or may describe a time-frequency resource covering a symbol time length in time and a subcarrier in frequency. A signal may be allocatable and/or allocated to a resource element. A subcarrier may be a subband of a carrier, e.g. as defined by a standard. A carrier may define a frequency and/or frequency band for transmission and/or reception. In some variants, a signal (jointly encoded/modulated) may cover more than one resource elements. A resource element may generally be as defined by a corresponding standard, e.g. NR or LTE. As symbol time length and/or subcarrier spacing (and/or numerology) may be different between different symbols and/or subcarriers, different resource elements may have different extension (length/width) in time and/or frequency domain, in particular resource elements pertaining to different carriers.

A resource generally may represent a time-frequency and/or code resource, on which signaling, e.g. according to a specific format, may be communicated, for example transmitted and/or received, and/or be intended for transmission and/or reception.

A border symbol may generally represent a starting symbol or an ending symbol for transmitting and/or receiving. A starting symbol may in particular be a starting symbol of uplink or sidelink signaling, for example control signaling or data signaling. Such signaling may be on a data channel or control channel, e.g. a physical channel, in particular a physical uplink shared channel (like PUSCH) or a sidelink data or shared channel, or a physical uplink control channel (like PUCCH) or a sidelink control channel. If the starting symbol is associated to control signaling (e.g., on a control channel), the control signaling may be in response to received signaling (in sidelink or downlink), e.g. representing acknowledgement signaling associated thereto, which may be HARQ or ARQ signaling. An ending symbol may represent an ending symbol (in time) of downlink or sidelink transmission or signaling, which may be intended or scheduled for the radio node or user equipment. Such downlink signaling may in particular be data signaling, e.g. on a physical downlink channel like a shared channel, e.g. a PDSCH (Physical Downlink Shared Channel). A starting symbol may be determined based on, and/or in relation to, such an ending symbol.

Configuring a radio node, in particular a terminal or user equipment, may refer to the radio node being adapted or caused or set and/or instructed to operate according to the configuration. Configuring may be done by another device, e.g., a network node (for example, a radio node of the network like a base station or eNodeB) or network, in which case it may comprise transmitting configuration data to the radio node to be configured. Such configuration data may represent the configuration to be configured and/or comprise one or more instruction pertaining to a configuration, e.g. a configuration for transmitting and/or receiving on allocated resources, in particular frequency resources. A radio node may configure itself, e.g., based on configuration data received from a network or network node. A network node may utilise, and/or be adapted to utilise, its circuitry/les for configuring. Allocation information may be considered a form of configuration data. Configuration data may comprise and/or be represented by configuration information, and/or one or more corresponding indications and/or message/s

Generally, configuring may include determining configuration data representing the configuration and providing, e.g. transmitting, it to one or more other nodes (parallel and/or sequentially), which may transmit it further to the radio node (or another node, which may be repeated until it reaches the wireless device). Alternatively, or additionally, configuring a radio node, e.g., by a network node or other device, may include receiving configuration data and/or data pertaining to configuration data, e.g., from another node like a network node, which may be a higher-level node of the network, and/or transmitting received configuration data to the radio node. Accordingly, determining a configuration and transmitting the configuration data to the radio node may be performed by different network nodes or entities, which may be able to communicate via a suitable interface, e.g., an X2 interface in the case of LTE or a corresponding interface for NR. Configuring a terminal may comprise scheduling downlink and/or uplink transmissions for the terminal, e.g. downlink data and/or downlink control signaling and/or DCI and/or uplink control or data or communication signaling, in particular acknowledgement signaling, and/or configuring resources and/or a resource pool therefor.

A resource structure may be considered to be neighbored in frequency domain by another resource structure, if they share a common border frequency, e.g. one as an upper frequency border and the other as a lower frequency border. Such a border may for example be represented by the upper end of a bandwidth assigned to a subcarrier n, which also represents the lower end of a bandwidth assigned to a subcarrier n+1. A resource structure may be considered to be neighbored in time domain by another resource structure, if they share a common border time, e.g. one as an upper (or right in the figures) border and the other as a lower (or left in the figures) border. Such a border may for example be represented by the end of the symbol time interval assigned to a symbol n, which also represents the beginning of a symbol time interval assigned to a symbol n+1.

Generally, a resource structure being neighbored by another resource structure in a domain may also be referred to as abutting and/or bordering the other resource structure in the domain.

A resource structure may general represent a structure in time and/or frequency domain, in particular representing a time interval and a frequency interval. A resource structure may comprise and/or be comprised of resource elements, and/or the time interval of a resource structure may comprise and/or be comprised of symbol time interval/s, and/or the frequency interval of a resource structure may comprise and/or be comprised of subcarrier/s. A resource element may be considered an example for a resource structure, a slot or mini-slot or a Physical Resource Block (PRB) or parts thereof may be considered others. A resource structure may be associated to a specific channel, e.g. a PUSCH or PUCCH, in particular resource structure smaller than a slot or PRB.

Examples of a resource structure in frequency domain comprise a bandwidth or band, or a bandwidth part. A bandwidth part may be a part of a bandwidth available for a radio node for communicating, e.g. due to circuitry and/or configuration and/or regulations and/or a standard. A bandwidth part may be configured or configurable to a radio node. In some variants, a bandwidth part may be the part of a bandwidth used for communicating, e.g. transmitting and/or receiving, by a radio node. The bandwidth part may be smaller than the bandwidth (which may be a device bandwidth defined by the circuitry/configuration of a device, and/or a system bandwidth, e.g. available for a RAN). It may be considered that a bandwidth part comprises one or more resource blocks or resource block groups, in particular one or more PRBs or PRB groups. A bandwidth part may pertain to, and/or comprise, one or more carriers.

A carrier may generally represent a frequency range or band and/or pertain to a central frequency and an associated frequency interval. It may be considered that a carrier comprises a plurality of subcarriers. A carrier may have assigned to it a central frequency or center frequency interval, e.g. represented by one or more subcarriers (to each subcarrier there may be generally assigned a frequency bandwidth or interval). Different carriers may be non-overlapping, and/or may be neighboring in frequency domain.

It should be noted that the term “radio” in this disclosure may be considered to pertain to wireless communication in general, and may also include wireless communication utilising microwave and/or millimeter and/or other frequencies, in particular between 100 MHz or 1 GHz, and 100 GHz or 20 or 10 GHz. Such communication may utilise one or more carriers.

A radio node, in particular a network node or a terminal, may generally be any device adapted for transmitting and/or receiving radio and/or wireless signals and/or data, in particular communication data, in particular on at least one carrier. The at least one carrier may comprise a carrier accessed based on a LBT procedure (which may be called LBT carrier), e.g., an unlicensed carrier. It may be considered that the carrier is part of a carrier aggregate.

Receiving or transmitting on a cell or carrier may refer to receiving or transmitting utilizing a frequency (band) or spectrum associated to the cell or carrier. A cell may generally comprise and/or be defined by or for one or more carriers, in particular at least one carrier for UL communication/transmission (called UL carrier) and at least one carrier for DL communication/transmission (called DL carrier). It may be considered that a cell comprises different numbers of UL carriers and DL carriers. Alternatively, or additionally, a cell may comprise at least one carrier for UL communication/transmission and DL communication/transmission, e.g., in TDD-based approaches.

A channel may generally be a logical, transport or physical channel. A channel may comprise and/or be arranged on one or more carriers, in particular a plurality of subcarriers. A channel carrying and/or for carrying control signaling/control information may be considered a control channel, in particular if it is a physical layer channel and/or if it carries control plane information. Analogously, a channel carrying and/or for carrying data signaling/user information may be considered a data channel, in particular if it is a physical layer channel and/or if it carries user plane information. A channel may be defined for a specific communication direction, or for two complementary communication directions (e.g., UL and DL, or sidelink in two directions), in which case it may be considered to have two component channels, one for each direction. Examples of channels comprise a channel for low latency and/or high reliability transmission, in particular a channel for Ultra-Reliable Low Latency Communication (URLLC), which may be for control and/or data.

In general, a symbol may represent and/or be associated to a symbol time length, which may be dependent on the carrier and/or subcarrier spacing and/or numerology of the associated carrier. Accordingly, a symbol may be considered to indicate a time interval having a symbol time length in relation to frequency domain. A symbol time length may be dependent on a carrier frequency and/or bandwidth and/or numerology and/or subcarrier spacing of, or associated to, a symbol. Accordingly, different symbols may have different symbol time lengths. In particular, numerologies with different subcarrier spacings may have different symbol time length. Generally, a symbol time length may be based on, and/or include, a guard time interval or cyclic extension, e.g. prefix or postfix.

A sidelink may generally represent a communication channel (or channel structure) between two UEs and/or terminals, in which data is transmitted between the participants (UEs and/or terminals) via the communication channel, e.g. directly and/or without being relayed via a network node. A sidelink may be established only and/or directly via air interface/s of the participant, which may be directly linked via the sidelink communication channel. In some variants, sidelink communication may be performed without interaction by a network node, e.g. on fixedly defined resources and/or on resources negotiated between the participants. Alternatively, or additionally, it may be considered that a network node provides some control functionality, e.g. by configuring resources, in particular one or more resource pool/s, for sidelink communication, and/or monitoring a sidelink, e.g. for charging purposes.

Sidelink communication may also be referred to as device-to-device (D2D) communication, and/or in some cases as ProSe (Proximity Services) communication, e.g. in the context of LTE. A sidelink may be implemented in the context of V2x communication (Vehicular communication), e.g. V2V (Vehicle-to-Vehicle), V2I (Vehicle-to-Infrastructure) and/or V2P (Vehicle-to-Person). Any device adapted for sidelink communication may be considered a user equipment or terminal.

A sidelink communication channel (or structure) may comprise one or more (e.g., physical or logical) channels, e.g. a PSCCH (Physical Sidelink Control CHannel, which may for example carry control information like an acknowledgement position indication, and/or a PSSCH (Physical Sidelink Shared CHannel, which for example may carry data and/or acknowledgement signaling). It may be considered that a sidelink communication channel (or structure) pertains to and/or used one or more carrier/s and/or frequency range/s associated to, and/or being used by, cellular communication, e.g. according to a specific license and/or standard. Participants may share a (physical) channel and/or resources, in particular in frequency domain and/or related to a frequency resource like a carrier) of a sidelink, such that two or more participants transmit thereon, e.g. simultaneously, and/or time-shifted, and/or there may be associated specific channels and/or resources to specific participants, so that for example only one participant transmits on a specific channel or on a specific resource or specific resources, e.g., in frequency domain and/or related to one or more carriers or subcarriers.

A sidelink may comply with, and/or be implemented according to, a specific standard, e.g. a LTE-based standard and/or NR. A sidelink may utilise TDD (Time Division Duplex) and/or FDD (Frequency Division Duplex) technology, e.g. as configured by a network node, and/or preconfigured and/or negotiated between the participants. A user equipment may be considered to be adapted for sidelink communication if it, and/or its radio circuitry and/or processing circuitry, is adapted for utilising a sidelink, e.g. on one or more frequency ranges and/or carriers and/or in one or more formats, in particular according to a specific standard. It may be generally considered that a Radio Access Network is defined by two participants of a sidelink communication. Alternatively, or additionally, a Radio Access Network may be represented, and/or defined with, and/or be related to a network node and/or communication with such a node.

Communication or communicating may generally comprise transmitting and/or receiving signaling. Communication on a sidelink (or sidelink signaling) may comprise utilising the sidelink for communication (respectively, for signaling). Sidelink transmission and/or transmitting on a sidelink may be considered to comprise transmission utilising the sidelink, e.g. associated resources and/or transmission formats and/or circuitry and/or the air interface. Sidelink reception and/or receiving on a sidelink may be considered to comprise reception utilising the sidelink, e.g. associated resources and/or transmission formats and/or circuitry and/or the air interface. Sidelink control information (e.g., SCI) may generally be considered to comprise control information transmitted utilising a sidelink.

Generally, carrier aggregation (CA) may refer to the concept of a radio connection and/or communication link between a wireless and/or cellular communication network and/or network node and a terminal or on a sidelink comprising a plurality of carriers for at least one direction of transmission (e.g. DL and/or UL), as well as to the aggregate of carriers. A corresponding communication link may be referred to as carrier aggregated communication link or CA communication link; carriers in a carrier aggregate may be referred to as component carriers (CC). In such a link, data may be transmitted over more than one of the carriers and/or all the carriers of the carrier aggregation (the aggregate of carriers). A carrier aggregation may comprise one (or more) dedicated control carriers and/or primary carriers (which may e.g. be referred to as primary component carrier or PCC), over which control information may be transmitted, wherein the control information may refer to the primary carrier and other carriers, which may be referred to as secondary carriers (or secondary component carrier, SCC). However, in some approaches, control information may be send over more than one carrier of an aggregate, e.g. one or more PCCs and one PCC and one or more SCCs.

A transmission may generally pertain to a specific channel and/or specific resources, in particular with a starting symbol and ending symbol in time, covering the interval therebetween. A scheduled transmission may be a transmission scheduled and/or expected and/or for which resources are scheduled or provided or reserved. However, not every scheduled transmission has to be realized. For example, a scheduled downlink transmission may not be received, or a scheduled uplink transmission may not be transmitted due to power limitations, or other influences (e.g., a channel on an unlicensed carrier being occupied). A transmission may be scheduled for a transmission timing substructure (e.g., a mini-slot, and/or covering only a part of a transmission timing structure) within a transmission timing structure like a slot. A border symbol may be indicative of a symbol in the transmission timing structure at which the transmission starts or ends.

Predefined in the context of this disclosure may refer to the related information being defined for example in a standard, and/or being available without specific configuration from a network or network node, e.g. stored in memory, for example independent of being configured. Configured or configurable may be considered to pertain to the corresponding information being set/configured, e.g. by the network or a network node.

A configuration or schedule, like a mini-slot configuration and/or structure configuration, may schedule transmissions, e.g. for the time/transmissions it is valid, and/or transmissions may be scheduled by separate signaling or separate configuration, e.g. separate RRC signaling and/or downlink control information signaling. The transmission/s scheduled may represent signaling to be transmitted by the device for which it is scheduled, or signaling to be received by the device for which it is scheduled, depending on which side of a communication the device is. It should be noted that downlink control information or specifically DCI signaling may be considered physical layer signaling, in contrast to higher layer signaling like MAC (Medium Access Control) signaling or RRC layer signaling. The higher the layer of signaling is, the less frequent/the more time/resource consuming it may be considered, at least partially due to the information contained in such signaling having to be passed on through several layers, each layer requiring processing and handling.

A scheduled transmission, and/or transmission timing structure like a mini-slot or slot, may pertain to a specific channel, in particular a physical uplink shared channel, a physical uplink control channel, or a physical downlink shared channel, e.g. PUSCH, PUCCH or PDSCH, and/or may pertain to a specific cell and/or carrier aggregation. A corresponding configuration, e.g. scheduling configuration or symbol configuration may pertain to such channel, cell and/or carrier aggregation. It may be considered that the scheduled transmission represents transmission on a physical channel, in particular a shared physical channel, for example a physical uplink shared channel or physical downlink shared channel. For such channels, semi-persistent configuring may be particularly suitable.

Generally, a configuration may be a configuration indicating timing, and/or be represented or configured with corresponding configuration data. A configuration may be embedded in, and/or comprised in, a message or configuration or corresponding data, which may indicate and/or schedule resources, in particular semi-persistently and/or semi-statically.

A control region of a transmission timing structure may be an interval in time for intended or scheduled or reserved for control signaling, in particular downlink control signaling, and/or for a specific control channel, e.g. a physical downlink control channel like PDCCH. The interval may comprise, and/or consist of, a number of symbols in time, which may be configured or configurable, e.g. by (UE-specific) dedicated signaling (which may be single-cast, for example addressed to or intended for a specific UE), e.g. on a PDCCH, or RRC signaling, or on a multicast or broadcast channel. In general, the transmission timing structure may comprise a control region covering a configurable number of symbols. It may be considered that in general the border symbol is configured to be after the control region in time.

The duration of a symbol (symbol time length or interval) of the transmission timing structure may generally be dependent on a numerology and/or carrier, wherein the numerology and/or carrier may be configurable. The numerology may be the numerology to be used for the scheduled transmission.

Scheduling a device, or for a device, and/or related transmission or signaling, may be considered comprising, or being a form of, configuring the device with resources, and/or of indicating to the device resources, e.g. to use for communicating. Scheduling may in particular pertain to a transmission timing structure, or a substructure thereof (e.g., a slot or a mini-slot, which may be considered a substructure of a slot). It may be considered that a border symbol may be identified and/or determined in relation to the transmission timing structure even if for a substructure being scheduled, e.g. if an underlying timing grid is defined based on the transmission timing structure. Signaling indicating scheduling may comprise corresponding scheduling information and/or be considered to represent or contain configuration data indicating the scheduled transmission and/or comprising scheduling information. Such configuration data or signaling may be considered a resource configuration or scheduling configuration. It should be noted that such a configuration (in particular as single message) in some cases may not be complete without other configuration data, e.g. configured with other signaling, e.g. higher layer signaling. In particular, the symbol configuration may be provided in addition to scheduling/resource configuration to identify exactly which symbols are assigned to a scheduled transmission. A scheduling (or resource) configuration may indicate transmission timing structure/s and/or resource amount (e.g., in number of symbols or length in time) for a scheduled transmission.

A scheduled transmission may be transmission scheduled, e.g. by the network or network node. Transmission may in this context may be uplink (UL) or downlink (DL) or sidelink (SL) transmission. A device, e.g. a user equipment, for which the scheduled transmission is scheduled, may accordingly be scheduled to receive (e.g., in DL or SL), or to transmit (e.g. in UL or SL) the scheduled transmission. Scheduling transmission may in particular be considered to comprise configuring a scheduled device with resource/s for this transmission, and/or informing the device that the transmission is intended and/or scheduled for some resources. A transmission may be scheduled to cover a time interval, in particular a successive number of symbols, which may form a continuous interval in time between (and including) a starting symbol and an ending symbols. The starting symbol and the ending symbol of a (e.g., scheduled) transmission may be within the same transmission timing structure, e.g. the same slot. However, in some cases, the ending symbol may be in a later transmission timing structure than the starting symbol, in particular a structure following in time. To a scheduled transmission, a duration may be associated and/or indicated, e.g. in a number of symbols or associated time intervals. In some variants, there may be different transmissions scheduled in the same transmission timing structure. A scheduled transmission may be considered to be associated to a specific channel, e.g. a shared channel like PUSCH or PDSCH.

In the context of this disclosure, there may be distinguished between dynamically scheduled or aperiodic transmission and/or configuration, and semi-static or semi-persistent or periodic transmission and/or configuration. The term “dynamic” or similar terms may generally pertain to configuration/transmission valid and/or scheduled and/or configured for (relatively) short timescales and/or a (e.g., predefined and/or configured and/or limited and/or definite) number of occurrences and/or transmission timing structures, e.g. one or more transmission timing structures like slots or slot aggregations, and/or for one or more (e.g., specific number) of transmission/occurrences. Dynamic configuration may be based on low-level signaling, e.g. control signaling on the physical layer and/or MAC layer, in particular in the form of DCI or SCI. Periodic/semi-static may pertain to longer timescales, e.g. several slots and/or more than one frame, and/or a non-defined number of occurrences, e.g., until a dynamic configuration contradicts, or until a new periodic configuration arrives. A periodic or semi-static configuration may be based on, and/or be configured with, higher-layer signaling, in particular RCL layer signaling and/or RRC signaling and/or MAC signaling.

A transmission timing structure may comprise a plurality of symbols, and/or define an interval comprising several symbols (respectively their associated time intervals). In the context of this disclosure, it should be noted that a reference to a symbol for ease of reference may be interpreted to refer to the time domain projection or time interval or time component or duration or length in time of the symbol, unless it is clear from the context that the frequency domain component also has to be considered. Examples of transmission timing structures include slot, subframe, mini-slot (which also may be considered a substructure of a slot), slot aggregation (which may comprise a plurality of slots and may be considered a superstructure of a slot), respectively their time domain component. A transmission timing structure may generally comprise a plurality of symbols defining the time domain extension (e.g., interval or length or duration) of the transmission timing structure, and arranged neighboring to each other in a numbered sequence. A timing structure (which may also be considered or implemented as synchronisation structure) may be defined by a succession of such transmission timing structures, which may for example define a timing grid with symbols representing the smallest grid structures. A transmission timing structure, and/or a border symbol or a scheduled transmission may be determined or scheduled in relation to such a timing grid. A transmission timing structure of reception may be the transmission timing structure in which the scheduling control signaling is received, e.g. in relation to the timing grid. A transmission timing structure may in particular be a slot or subframe or in some cases, a mini-slot.

Feedback signaling may be considered a form or control signaling, e.g. uplink or sidelink control signaling, like UCI (Uplink Control Information) signaling or SCI (Sidelink Control Information) signaling. Feedback signaling may in particular comprise and/or represent acknowledgement signaling and/or acknowledgement information and/or measurement reporting.

Acknowledgement information may comprise an indication of a specific value or state for an acknowledgement signaling process, e.g. ACK or NACK or DTX. Such an indication may for example represent a bit or bit value or bit pattern or an information switch. Different levels of acknowledgement information, e.g. providing differentiated information about quality of reception and/or error position in received data element/s may be considered and/or represented by control signaling. Acknowledgment information may generally indicate acknowledgment or non-acknowledgment or non-reception or different levels thereof, e.g. representing ACK or NACK or DTX. Acknowledgment information may pertain to one acknowledgement signaling process. Acknowledgement signaling may comprise acknowledgement information pertaining to one or more acknowledgement signaling processes, in particular one or more HARQ or ARQ processes. It may be considered that to each acknowledgment signaling process the acknowledgement information pertains to, a specific number of bits of the information size of the control signaling is assigned. Measurement reporting signaling may comprise measurement information.

Signaling may generally comprise one or more symbols and/or signals and/or messages. A signal may comprise and/or represent one or more bits, which may be modulated into a common modulated signal. An indication may represent signaling, and/or be implemented as a signal, or as a plurality of signals. One or more signals may be included in and/or represented by a message. Signaling, in particular control signaling, may comprise a plurality of signals and/or messages, which may be transmitted on different carriers and/or be associated to different acknowledgement signaling processes, e.g. representing and/or pertaining to one or more such processes. An indication may comprise signaling and/or a plurality of signals and/or messages and/or may be comprised therein, which may be transmitted on different carriers and/or be associated to different acknowledgement signaling processes, e.g. representing and/or pertaining to one or more such processes.

Signaling utilising, and/or on and/or associated to, resources or a resource structure may be signaling covering the resources or structure, signaling on the associated frequency/ies and/or in the associated time interval/s. It may be considered that a signaling resource structure comprises and/or encompasses one or more substructures, which may be associated to one or more different channels and/or types of signaling and/or comprise one or more holes (resource element/s not scheduled for transmissions or reception of transmissions). A resource substructure, e.g. a feedback resource structure, may generally be continuous in time and/or frequency, within the associated intervals. It may be considered that a substructure, in particular a feedback resource structure, represents a rectangle filled with one or more resource elements in time/frequency space. However, in some cases, a resource structure or substructure, in particular a frequency resource range, may represent a non-continuous pattern of resources in one or more domains, e.g. time and/or frequency. The resource elements of a substructure may be scheduled for associated signaling.

It should generally be noted that the number of bits or a bit rate associated to specific signaling that can be carried on a resource element may be based on a modulation and coding scheme (MCS). Thus, bits or a bit rate may be seen as a form of resources representing a resource structure or range in frequency and/or time, e.g. depending on MCS. The MCS may be configured or configurable, e.g. by control signaling, e.g. DCI or MAC (Medium Access Control) or RRC (Radio Resource Control) signaling.

Different formats of for control information may be considered, e.g. different formats for a control channel like a Physical Uplink Control Channel (PUCCH). PUCCH may carry control information or corresponding control signaling, e.g. Uplink Control Information (UCI). UCI may comprise feedback signaling, and/or acknowledgement signaling like HARQ feedback (ACK/NACK), and/or measurement information signaling, e.g. comprising Channel Quality Information (CQI), and/or Scheduling Request (SR) signaling. One of the supported PUCCH formats may be short, and may e.g. occur at the end of a slot interval, and/or multiplexed and/or neighboring to PUSCH. Similar control information may be provided on a sidelink, e.g. as Sidelink Control Information (SCI), in particular on a (physical) sidelink control channel, like a (P)SCCH.

A code block may be considered a subelement of a data element like a transport block, e.g., a transport block may comprise a one or a plurality of code blocks.

A scheduling assignment may be configured with control signaling, e.g. downlink control signaling or sidelink control signaling. Such controls signaling may be considered to represent and/or comprise scheduling signaling, which may indicate scheduling information. A scheduling assignment may be considered scheduling information indicating scheduling of signaling/transmission of signaling, in particular pertaining to signaling received or to be received by the device configured with the scheduling assignment. It may be considered that a scheduling assignment may indicate data (e.g., data block or element and/or channel and/or data stream) and/or an (associated) acknowledgement signaling process and/or resource/s on which the data (or, in some cases, reference signaling) is to be received and/or indicate resource/s for associated feedback signaling, and/or a feedback resource range on which associated feedback signaling is to be transmitted. Transmission associated to an acknowledgement signaling process, and/or the associated resources or resource structure, may be configured and/or scheduled, for example by a scheduling assignment. Different scheduling assignments may be associated to different acknowledgement signaling processes. A scheduling assignment may be considered an example of downlink control information or signaling, e.g. if transmitted by a network node and/or provided on downlink (or sidelink control information if transmitted using a sidelink and/or by a user equipment).

A scheduling grant (e.g., uplink grant) may represent control signaling (e.g., downlink control information/signaling). It may be considered that a scheduling grant configures the signaling resource range and/or resources for uplink (or sidelink) signaling, in particular uplink control signaling and/or feedback signaling, e.g. acknowledgement signaling. Configuring the signaling resource range and/or resources may comprise configuring or scheduling it for transmission by the configured radio node. A scheduling grant may indicate a channel and/or possible channels to be used/usable for the feedback signaling, in particular whether a shared channel like a PUSCH may be used/is to be used. A scheduling grant may generally indicate uplink resource/s and/or an uplink channel and/or a format for control information pertaining to associated scheduling assignments. Both grant and assignment/s may be considered (downlink or sidelink) control information, and/or be associated to, and/or transmitted with, different messages.

A resource structure in frequency domain (which may be referred to as frequency interval and/or range) may be represented by a subcarrier grouping. A subcarrier grouping may comprise one or more subcarriers, each of which may represent a specific frequency interval, and/or bandwidth. The bandwidth of a subcarrier, the length of the interval in frequency domain, may be determined by the subcarrier spacing and/or numerology. The subcarriers may be arranged such that each subcarrier neighbours at least one other subcarrier of the grouping in frequency space (for grouping sizes larger than 1). The subcarriers of a grouping may be associated to the same carrier, e.g. configurably or configured of predefined. A physical resource block may be considered representative of a grouping (in frequency domain). A subcarrier grouping may be considered to be associated to a specific channel and/or type of signaling, it transmission for such channel or signaling is scheduled and/or transmitted and/or intended and/or configured for at least one, or a plurality, or all subcarriers in the grouping. Such association may be time-dependent, e.g. configured or configurable or predefined, and/or dynamic or semi-static. The association may be different for different devices, e.g. configured or configurable or predefined, and/or dynamic or semi-static. Patterns of subcarrier groupings may be considered, which may comprise one or more subcarrier groupings (which may be associated to same or different signalings/channels), and/or one or more groupings without associated signaling (e.g., as seen from a specific device). An example of a pattern is a comb, for which between pairs of groupings associated to the same signaling/channel there are arranged one or more groupings associated to one or more different channels and/or signaling types, and/or one or more groupings without associated channel/signaling).

Example types of signaling comprise signaling of a specific communication direction, in particular, uplink signaling, downlink signaling, sidelink signaling, as well as reference signaling (e.g., SRS or CRS or CSI-RS), communication signaling, control signaling, and/or signaling associated to a specific channel like PUSCH, PDSCH, PUCCH, PDCCH, PSCCH, PSSCH, etc.).

In this disclosure, for purposes of explanation and not limitation, specific details are set forth (such as particular network functions, processes and signaling steps) in order to provide a thorough understanding of the technique presented herein. It will be apparent to one skilled in the art that the present concepts and aspects may be practiced in other variants and variants that depart from these specific details.

For example, the concepts and variants are partially described in the context of Long Term Evolution (LTE) or LTE-Advanced (LTE-A) or New Radio mobile or wireless communications technologies; however, this does not rule out the use of the present concepts and aspects in connection with additional or alternative mobile communication technologies such as the Global System for Mobile Communications (GSM). While described variants may pertain to certain Technical Specifications (TSs) of the Third Generation Partnership Project (3GPP), it will be appreciated that the present approaches, concepts and aspects could also be realized in connection with different Performance Management (PM) specifications.

Moreover, those skilled in the art will appreciate that the services, functions and steps explained herein may be implemented using software functioning in conjunction with a programmed microprocessor, or using an Application Specific Integrated Circuit (ASIC), a Digital Signal Processor (DSP), a Field Programmable Gate Array (FPGA) or general purpose computer. It will also be appreciated that while the variants described herein are elucidated in the context of methods and devices, the concepts and aspects presented herein may also be embodied in a program product as well as in a system comprising control circuitry, e.g. a computer processor and a memory coupled to the processor, wherein the memory is encoded with one or more programs or program products that execute the services, functions and steps disclosed herein.

It is believed that the advantages of the aspects and variants presented herein will be fully understood from the foregoing description, and it will be apparent that various changes may be made in the form, constructions and arrangement of the exemplary aspects thereof without departing from the scope of the concepts and aspects described herein or without sacrificing all of its advantageous effects. The aspects presented herein can be varied in many ways.

Some useful abbreviations comprise

| Abbreviation | Explanation |
|---|---|
| ACK/NACK | Acknowledgment/Negative Acknowledgement |
| ARQ | Automatic Repeat reQuest |
| CAZAC | Constant Amplitude Zero Cross Correlation |
| CBG | Code Block Group |
| CDM | Code Division Multiplex |
| CM | Cubic Metric |
| CQI | Channel Quality Information |
| CRC | Cyclic Redundancy Check |
| CRS | Common reference signal |
| CSI | Channel State Information |
| CSI-RS | Channel state information reference signal |
| DAI | Downlink Assignment Indicator |
| DCI | Downlink Control Information |
| DFT | Discrete Fourier Transform |
| DM(−)RS | Demodulation reference signal(ing) |
| FDM | Frequency Division Multiplex |
| HARQ | Hybrid Automatic Repeat Request |
| IFFT | Inverse Fast Fourier Transform |
| MBB | Mobile Broadband |
| MCS | Modulation and Coding Scheme |
| MIMO | Multiple-input-multiple-output |
| MRC | Maximum-ratio combining |
| MRT | Maximum-ratio transmission |
| MU-MIMO | Multiuser multiple-input-multiple-output |
| OFDM/A | Orthogonal Frequency Division Multiplex/ |
| | Multiple Access |
| PAPR | Peak to Average Power Ratio |
| PDCCH | Physical Downlink Control Channel |
| PDSCH | Physical Downlink Shared Channel |
| PRACH | Physical Random Access CHannel |
| PRB | Physical Resource Block |
| PUCCH | Physical Uplink Control Channel |
| PUSCH | Physical Uplink Shared Channel |
| (P)SCCH | (Physical) Sidelink Control Channel |
| (P)SSCH | (Physical) Sidelink Shared Channel |
| RB | Resource Block |
| RRC | Radio Resource Control |
| SC-FDM/A | Single Carrier Frequency Division Multiplex/ |
| | Multiple Access |
| SCI | Sidelink Control Information |
| SINR | Signal-to-interference-plus-noise ratio |
| SIR | Signal-to-interference ratio |
| SNR | Signal-to-noise-ratio |
| SR | Scheduling Request |
| SRS | Sounding Reference Signal(ing) |
| SVD | Singular-value decomposition |
| TDM | Time Division Multiplex |
| UCI | Uplink Control Information |
| UE | User Equipment |
| URLLC | Ultra Low Latency High Reliability Communication |
| VL-MIMO | Very-large multiple-input-multiple-output |
| ZF | Zero Forcing |

Abbreviations may be considered to follow 3GPP usage if applicable.

1-13. (canceled)

14. A method of operating a measuring radio node in a radio access network, the method comprising transmitting measurement reporting to the radio access network, wherein the measurement reporting is based on measurement performed on received data signaling.

15. The method of claim 14, wherein one or more of the following applies:
the measurement reporting is triggered by control signaling;
the measurement reporting pertains to one or more characteristics of the data signaling that are usable for link adaptation of subsequent data signaling; and
the measurement reporting is based on a measurement reference associated to the data signaling.

16. The method of claim 14, further comprising receiving subsequent data signaling, from the signaling radio node, according to a link adaptation based on the measurement reporting.

17. The method of claim 14, wherein the measurement reporting pertains to one or more of the following:
a single instance of data signaling,
one or more slots, and
a number (N) of symbols carrying data signaling, wherein N is 1, 2, or 3.

18. The method of claim 14, wherein the measurement reporting is also based on measurement performed on received reference signaling.

19. A measuring radio node configured to operate in a radio access network, wherein the measuring radio node comprises:
radio circuitry; and
processing circuitry operably coupled to the radio circuitry, whereby the processing circuitry and the radio circuitry are configured to transmit measurement reporting to the radio access network, wherein the measurement reporting is based on measurement performed on received data signaling.

20. The measuring radio node of claim 19, wherein one or more of the following applies:
the measurement reporting is triggered by control signaling;
the measurement reporting pertains to one or more characteristics of the data signaling that are usable for link adaptation of subsequent data signaling; and
the measurement reporting is based on a measurement reference associated to the data signaling.

21. The measuring radio node of claim 19, wherein the processing circuitry and radio circuitry are further configured to receive subsequent data signaling, from the signaling radio node, according to a link adaptation based on the measurement reporting.

22. The measuring radio node of claim 19, wherein the measurement reporting pertains to one or more of the following:
a single instance of data signaling,
one or more slots, and
a number (N) of symbols carrying data signaling, wherein N is 1, 2, or 3.

23. The measuring radio node of claim 19, wherein the measurement reporting is also based on measurement performed on received reference signaling.

24. A method of operating a signaling radio node in a radio access network, the method comprising performing link adaption for signaling based on measurement reporting received from a measuring radio node, wherein the measurement reporting is based on measurement performed on data signaling transmitted to the measuring radio node.

25. The method of claim 24, wherein one or more of the following applies:
the measurement reporting is triggered by control signaling;
the measurement reporting pertains to one or more characteristics of the data signaling that are usable for link adaptation of subsequent data signaling; and
the measurement reporting is based on a measurement reference associated to the data signaling.

26. The method of claim 24, further comprising transmitting subsequent data signaling to the measuring radio node based on the link adaptation.

27. The method of claim 24, wherein the measurement reporting pertains to one or more of the following:
a single instance of data signaling,
one or more slots, and
a number (N) of symbols carrying data signaling, wherein N is 1, 2, or 3.

28. The method of claim 24, wherein the measurement reporting is also based on measurement performed on reference signaling transmitted to the measuring radio node.

29. A signaling radio node configured to operate in a radio access network, wherein the signaling radio node comprises:
radio circuitry; and
processing circuitry operably coupled to the radio circuitry, whereby the processing circuitry and the radio circuitry are configured to perform link adaption for signaling based on measurement reporting received from a measuring radio node, wherein the measurement reporting is based on measurement performed on data signaling transmitted to the measuring radio node.

30. The signaling radio node of claim 29, wherein one or more of the following applies:
the measurement reporting is triggered by control signaling;
the measurement reporting pertains to one or more characteristics of the data signaling that are usable for link adaptation of subsequent data signaling; and
the measurement reporting is based on a measurement reference associated to the data signaling.

31. The signaling radio node of claim 29, wherein the processing circuitry and radio circuitry are further configured to transmit subsequent data signaling to the measuring radio node based on the link adaptation.

32. The signaling radio node of claim 29, wherein the measurement reporting pertains to one or more of the following:
a single instance of data signaling,
one or more slots, and
a number (N) of symbols carrying data signaling, wherein N is 1, 2, or 3.

33. The signaling radio node of claim 29, wherein the measurement reporting is also based on measurement performed on reference signaling transmitted to the measuring radio node.

34. A non-transitory, computer-readable medium storing computer-executable instructions that, when executed by processing circuitry, configure a measuring radio node in a radio access network to perform operations corresponding to the method of claim 14.

35. A non-transitory, computer-readable medium storing computer-executable instructions that, when executed by processing circuitry, configure a signaling radio node in a radio access network to perform operations corresponding to the method of claim 24.
